(19) United States
(12) Patent Application Publication
(10) Pub. No.: US 2026/0118107 A1
(43) Pub. Date: Apr. 30, 2026

(54) BLOCK MOUNTED CLEARANCE MEASURING STICK

(71) Applicant: QUANTA ASSOCIATES, L.P., Houston, TX (US)

(72) Inventor: Peter Raymond McKay, JR., Hudson, FL (US)

(73) Assignee: QUANTA ASSOCIATES, L.P., Houston, TX (US)

(21) Appl. No.: 19/371,155

(22) Filed: Oct. 28, 2025

Related U.S. Application Data
(60) Provisional application No. 63/712,893, filed on Oct. 28, 2024.

(51) Int. Cl. G01B 5/14

(52) U.S. Cl. CPC G01B 5/14

(57) ABSTRACT

The present disclosure relates generally to systems, apparatuses, and methods for repair or maintaining a conductor. In one embodiment, a block-mounted clearance measuring stick is disclosed, comprising: a rolling conductor block including a block housing and a roller mounted in the block housing, wherein the roller is configured to roll along a conductor; a stick support clamp pivotally mounted to a lower end of the block housing; a dielectric measuring stick configured to be mounted in the stick support clamp; a first dielectric elongate member mountable to a first end of the measuring stick; and a second dielectric elongate member mountable to the block housing.

### CROSS-REFERENCE TO RELATED APPLICATIONS

This disclosure claims priority to U.S. Provisional Application No. 63/712,893, titled “BLOCK MOUNTED CLEARANCE MEASURING STICK,” filed Oct. 28, 2024. The entire contents of the aforementioned application are incorporated by reference herein for all purposes.

### TECHNICAL FIELD

This disclosure generally relates to repair or maintenance operations on conductor networks. More particularly, and without limitation, the present disclosure relates to innovative methods and apparatus for measuring the safe working clearance distance for people, tools, and equipment from overhead powerline conductors. Certain aspects of the present disclosure generally relate to a conductor clearance measuring stick that is pivotally mounted to a rolling conductor block such that the conductor clearance distance may be measured safely and remotely.

### BACKGROUND

Measuring sticks for use by linemen are used to measure the clearance distance from conductors. Measuring sticks are insulated, handheld, and manually operated by a lineworker on the ground or in a bucket truck in near proximity to the conductors whose clearance distance is being measured.

However, such measuring sticks require a lineworker to be positioned sufficiently close to the overhead conductor. Such measuring sticks lack a solution, for example, for a lineworker on the ground or in the bucket truck who cannot be positioned sufficiently close to the overhead conductors, e.g., due to the terrain or height of the conductors. In such an example, the lineworker cannot reach or be elevated in the bucket truck to be in close proximity to the conductors in order to check the safe working clearance distance.

### SUMMARY

The embodiments of the present disclosure set forth herein relate to a conductor clearance measuring stick.

One aspect of the present disclosure is directed to a block-mounted clearance measuring stick, comprising: a rolling conductor block, a stick support clamp, a dielectric measuring stick, a first dielectric elongate member, and a second dielectric elongate member. The rolling conductor block may include a block housing and a roller mounted in the block housing. The roller may be configured to roll along a conductor. The stick support clamp may be pivotally mounted to a lower end of the block housing. The dielectric measuring stick may be configured to be mounted in the stick support clamp. The first dielectric elongate member may be mountable to a first end of the measuring stick. The second dielectric elongate member may be mountable to the block housing. Another aspect of the present disclosure is directed to a method of using a block-mounted clearance measuring stick, the method comprising: providing a block-mounted clearance stick; mounting the measuring stick in the stick support clamp; mounting the block housing on the first conductor; while holding tension on the first dielectric elongate member, pulling at least the second dielectric elongate member; and releasing the tension on the first dielectric elongate member. The block-mounted clearance stick may comprise: a rolling conductor block including a block housing and a roller mounted in the block housing, wherein the roller is configured to roll along a first conductor; a stick support clamp pivotally mounted to a lower end of the block housing; a dielectric measuring stick configured to be mounted in the stick support clamp; a first dielectric elongate member mountable to a first end of the measuring stick; and a second dielectric elongate member mountable to the block housing. Mounting the block housing on the first conductor may include passing the first conductor through a gate in the block housing so as to engage the first conductor with the roller. Holding tension on the first dielectric elongate member may keep the first end of the measuring stick away from a second conductor. Pulling at least the second dielectric elongate member may include rolling the block-mounted clearance measuring stick along the first conductor via the roller. Releasing the tension on the first dielectric elongate member may include permitting the first end to rotate upwardly towards the second conductor.

Other aspects and embodiments of the present disclosure include the methods and processes comprising the steps described herein and also include the processes and modes of operation of the systems and devices described herein.

Yet other aspects and embodiments of the present disclosure will become apparent from the detailed description of the invention when read in conjunction with the attached drawings.

### BRIEF DESCRIPTION OF THE DRAWINGS

The example embodiments may be better understood, and numerous objects, features, and advantages made apparent to those skilled in the art by referencing the accompanying drawings. These drawings are used to illustrate only example embodiments and are not to be considered limiting of its scope, for the disclosure may admit to other equally effective example embodiments. The figures are not necessarily to scale, and certain features and certain views of the figures may be shown exaggerated in scale or in schematic in the interest of clarity and conciseness.

FIG. 1 illustrates a front elevation view of an example rolling conductor block-mounted clearance measuring stick when mounted on a first conductor and in a horizontal orientation, consistent with some disclosed embodiments.

FIG. 2 illustrates the example rolling conductor block-mounted clearance measuring stick depicted in FIG. 1 in a rotated orientation, consistent with some disclosed embodiments.

FIG. 3 illustrates the example rolling conductor block-mounted clearance measuring stick depicted in FIG. 1 in a vertical orientation, consistent with some disclosed embodiments.

FIG. 4 illustrates a rear elevation view of an example block housing in an open configuration, an example roller, and an example stick support clamp in an open configuration, consistent with some disclosed embodiments.

FIG. 5 illustrates a flow diagram of an example process for using a rolling conductor block-mounted clearance measuring stick, consistent with some disclosed embodiments.

Similar reference numerals may refer to similar parts throughout the several views of the drawings unless otherwise clearly represented.

### DETAILED DESCRIPTION

The following disclosure provides many different examples of embodiments, including examples of apparatuses, methods, techniques, and instruction sequences, for implementing different features of the provided subject matter. Specific simplified examples of components and arrangements are described below to explain the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used unless otherwise explicitly defined. The use of examples in this specification, including examples of any terms discussed herein, is illustrative only, and in no way limits the scope and meaning of the disclosure or of any exemplified term. Likewise, the present disclosure is not limited to various embodiments given in this specification.

Some embodiments of the present disclosure may be described as comprising a dielectric material. A dielectric material may include an electrically insulating material. For example, a dielectric material may include rubber, fiberglass, plastic, ceramic, or any other suitable dielectric material. Additionally, some embodiments of the present disclosure may be described as comprising a conductive material. A dielectric material may include an electrically insulating material. A conductive material may be configured to conduct electricity. For example, a conductive material may include a conductive metal (e.g., silver, copper, aluminum, gold, iron), a conductive metal alloy (e.g., aluminum-steel composite, steel, brass, bronze), graphite, or any other suitable conductive material.

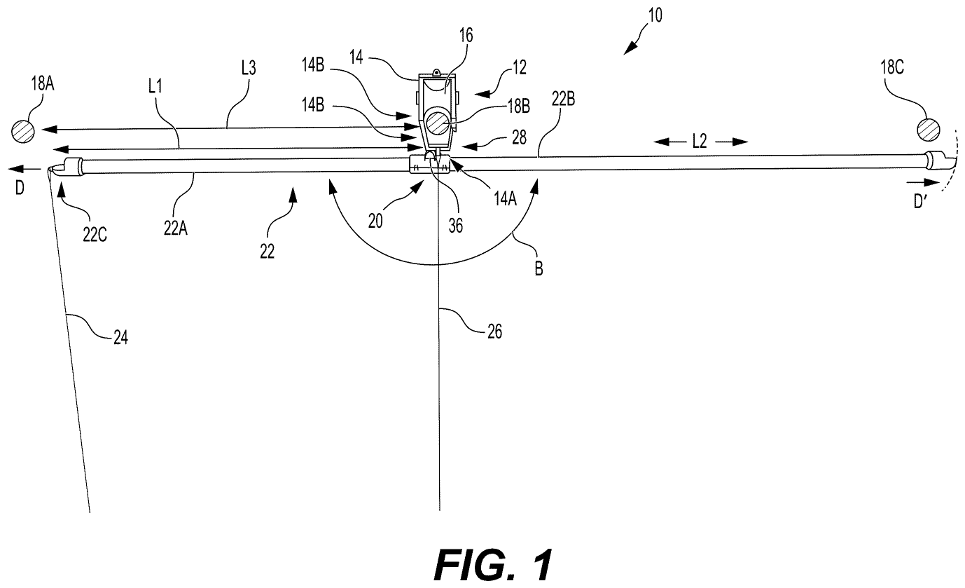

FIG. 1 illustrates a front elevation view of an example rolling conductor block-mounted clearance measuring stick 10 when mounted on a conductor 18B and in a horizontal orientation, consistent with some disclosed embodiments.

In some embodiments, rolling conductor block-mounted clearance measuring stick 10 may include a rolling conductor block 12. In some embodiments, rolling conductor block 12 may comprise a dielectric material. In some embodiments, rolling conductor block 12 may comprise a conductive material.

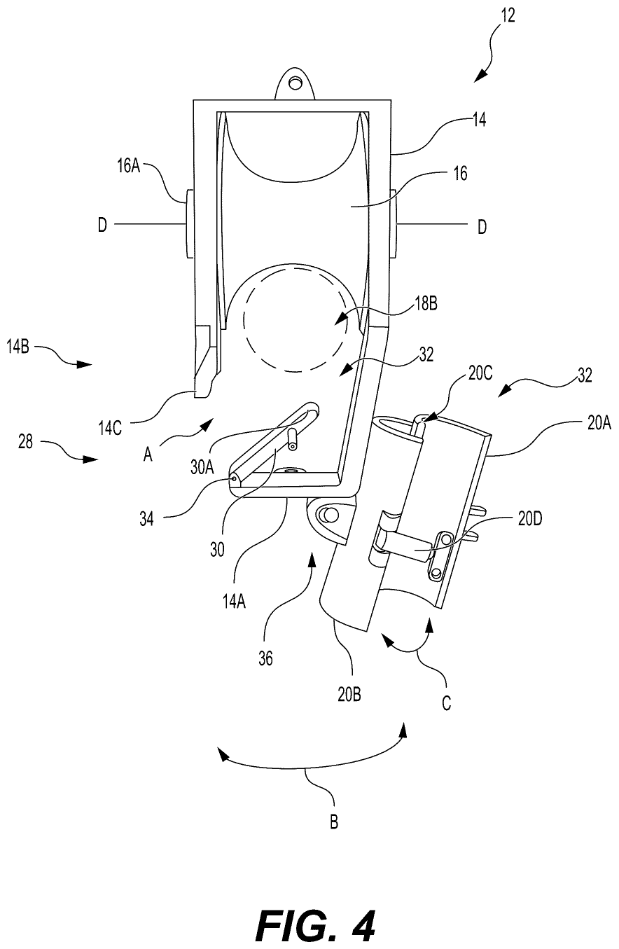

In some embodiments, rolling conductor block 12 may include a block housing 14. In some embodiments, block housing 14 may comprise a dielectric material. In some embodiments, block housing 14 may comprise a conductive material. In some embodiments, block housing 14 may include a self-closing gate mechanism 28, as further described and exemplified below with respect to FIG. 4.

In some embodiments, block housing 14 may include a roller 16. Roller 16 may be mounted in block housing 14. Roller 16 may be configured to roll along a conductor positioned in block housing 14. For example, and as depicted in FIG. 1, roller 16 may be configured to roll along conductor 18B. In some embodiments, roller 16 may comprise a dielectric material. In some embodiments, roller 16 may comprise a conductive material.

In some embodiments, one or more components of rolling conductor block 12 may comprise a similar material. For example, one or more of block housing 14 and roller 16 may comprise a conductive material. Additionally, or alternatively, in some embodiments, one or more components of rolling conductor block 12 may comprise a same material. For example, one or more of block housing 14 and roller 16 may each comprise steel. In some embodiments, one or more components of rolling conductor block 12 may comprise differing materials. For example, block housing 14 may comprise a dielectric material and roller 16 may comprise a conductive material.

In some embodiments, rolling conductor block-mounted clearance measuring stick 10 may include a stick support clamp 20. In some embodiments, stick support clamp 20 may comprise a dielectric material. In some embodiments, stick support clamp may comprise a conductive material. In some embodiments, stick support clamp 20 may be mounted to block housing 14. For example, stick support clamp 20 may be mounted under a lower end 14A of block housing 14.

In some embodiments, stick support clamp 20 may be pivotally mounted to block housing 14. For example, stick support clamp 20 may be pivotally mounted to block housing 14 by stick support clamp hinge 36. In some embodiments, stick support clamp hinge 36 may be a single degree-of-freedom hinge. For example, stick support clamp hinge 36 may be configured to constrain rotation of stick support clamp 20 to rotation in direction B in a vertical plane that is orthogonal to the longitudinal direction of a conductor 18B. Stick support clamp 20 and its components are further described and exemplified with respect to FIG. 4.

In some embodiments, rolling conductor block-mounted clearance measuring stick 10 may include a measuring stick 22. In some embodiments, measuring stick 22 may comprise a dielectric material. In some embodiments, measuring stick 22 may be mountable in stick support clamp 20. For example, measuring stick 22 may be inserted into stick support clamp 20. When mounted in stick support clamp 20, measuring stick 22 may include a first stick end 22A and a second stick end 22B, each stick end extending in an opposite direction from stick support clamp 20. For example, and as depicted in FIG. 1, first stick end 22A may extend in direction D and second stick end may extend in direction D′.

In some embodiments, measuring stick 22 may include at least one mount 22C. Mount 22C may be configured to be secured to measuring stick 22. For example, and as depicted in FIG. 1, mount 22C is secured to an end of first end 22A. Further, mount 22C may be configured to secure an end of a line, such as first line 24, as further described below. In some embodiments, a mount may include an eye bolt, an eye screw, a clevis, a shackle, a swivel eye hook, a threaded insert with a carabiner or snap hook, or a ferrule with a loop. Additionally, or alternatively, in some embodiments, a mount may include a clamp-on rope ring, a socket adapter with an eyelet, or a quick-release coupler. Additionally, or alternatively, in some embodiments, a mount may include a hole or through-bore in measuring stick 22 through which a line, such as first line 24, may be inserted.

In some embodiments, rolling conductor block-mounted clearance measuring stick 10 may include a first line 24, also referred to herein as a first elongate member. In some embodiments, first line 24 may comprise a dielectric material. In some embodiments, one end of first line 24 may be configured to be mounted to mount 22C. For example, first line 24 may be tied or otherwise secured to mount 22C. Further, first line 24 may hang down from measuring stick 22 when mounted to mount 22C. For example, first line 24, when secured to mount 22C, may hang freely and may be held and/or manipulated by a user, such as a lineworker. In some embodiments, block-mounted clearance measuring stick 10 may be configured such that maintaining tension on first line 24 may keep measuring stick 22 substantially horizontal and releasing tension on first line 24 may cause measuring stick 22 to rotate in direction B. For example, as depicted in FIG. 1, an operator or lineworker may be holding or pulling down on first line 24 to maintain a tension so that measuring stick 22 is substantially horizontal.

In some embodiments, rolling conductor block-mounted clearance measuring stick 10 may include a second line 26, also referred to herein as a second elongate member. In some embodiments, second line 26 may comprise a dielectric material. In some embodiments, one end of second line 26 may be configured to be mounted to block housing 14. For example, second line 26 may be tied or otherwise secured to block housing 14. Further, second line 26 may hang down from block housing 14 when mounted to block housing 14. For example, second line 26, when mounted to block housing 14, may hang freely and may be held and/or manipulated by a user, such as a lineworker. In some embodiment, block-mounted clearance measuring stick 10 may be configured such that, when mounted to a conductor, pulling second line 26 may cause block-mounted clearance measuring stick 10 to roll along the conductor in the pulled direction.

In some embodiments, at least one of first line 24 and second line 26 may comprise a first inflexible segment and a second flexible segment contiguous with the first inflexible segment. For example, the first inflexible segment may be secured to mount 22C or block housing 14, and the second flexible segment may be connected to the first inflexible segment. In some embodiments, the first inflexible segment may comprise a lightweight dielectric rod. For example, the first inflexible segment may comprise a stick, a rod, a pole, or any other elongate structure. In some embodiments, the second flexible segment may comprise a length of cordage. For example, the second flexible segment may comprise a rope, a cord, a string, or any other cordage.

In some embodiments, at least one of first line 24 and second line 26 may have a length associated with a height of an overhead conductor. For example, first line 24 and/or second line 26 may have a length such that they may extend from an overhead conductor to a user on the ground, such as a lineworker. This length may range from 4.5 meters to 25 meters and may depend on a height of an overhead conductor.

In some embodiments, stick support clamp 20 may be configured to rigidly clamp measuring stick 22. For example, when stick support clamp 20 is in a closed configuration around measuring stick 22 (e.g., as depicted in FIG. 1), measuring stick 22 may be unable to move or slide in direction D or D′. When stick support clamp 20 is in an open configuration (e.g., as depicted in FIG. 4), measuring stick 22 may be removable for, for example, transport or maintenance. Further, when stick support clamp 20 is in an open configuration, measuring stick 22 may be positioned relative to stick support clamp 20 to adjust length L1 of first stick end 22A and length L2 of second stick end 22B, respectively. For example, as length L1 increases, length L2 may decrease by a same amount.

In some embodiments, first stick end 22A may be configured to act as a clearance measuring end of measuring stick 22. In some embodiments, L1 may be equal to a required clearance distance between conductors 18A and 18B. For example, an operator or lineworker may position measuring stick 22 in stick support clamp 20 such that L1 equals a desired clearance distance associated with the conductors to be measured, such as, for example, conductors 18A and 18B. The desired clearance distance may depend on a voltage and/or arrangement of conductors. For example, the conductors may be arranged in a three-phase arrangement, such as depicted in FIG. 1 with conductors 18A, 18B, and 18C, or may be arranged in a two-phase arrangement. As depicted in FIG. 1, L3 may represent the physical distance between conductors 18A and 18B. In some embodiments, the clearance distance (L1) between conductors 18A and 18B may be at least equal to L3. Once the desired clearance distance is set, the operator or lineworker may secure measuring stick 22 by rigidly clamping stick support clamp 20. The operator or lineworker may then mount rolling conductor block 12 on a conductor and may pull rolling conductor block 12 along the conductor by pulling on second line 26 to, for example, a desired location for taking a clearance distance measurement.

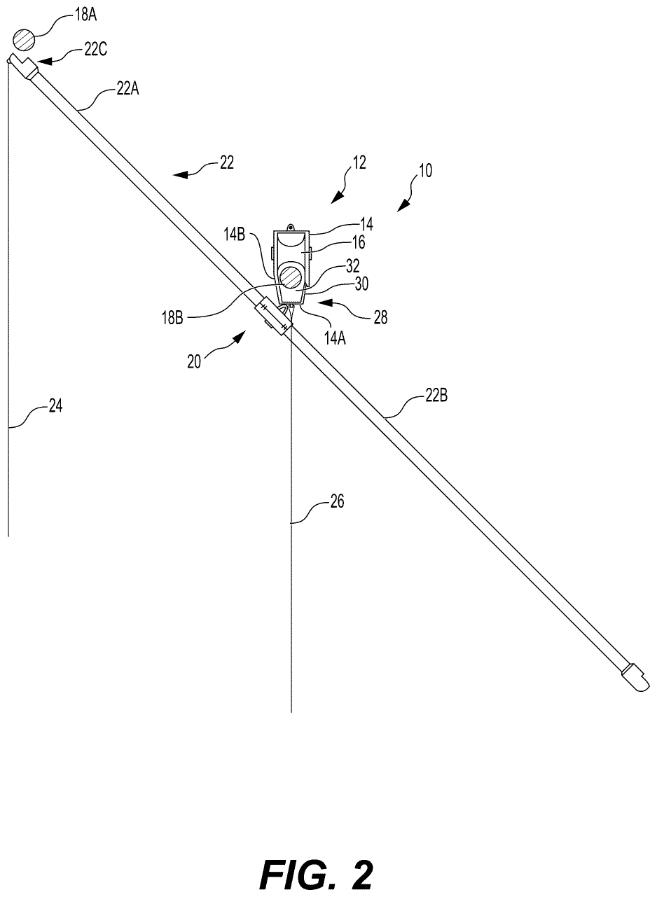

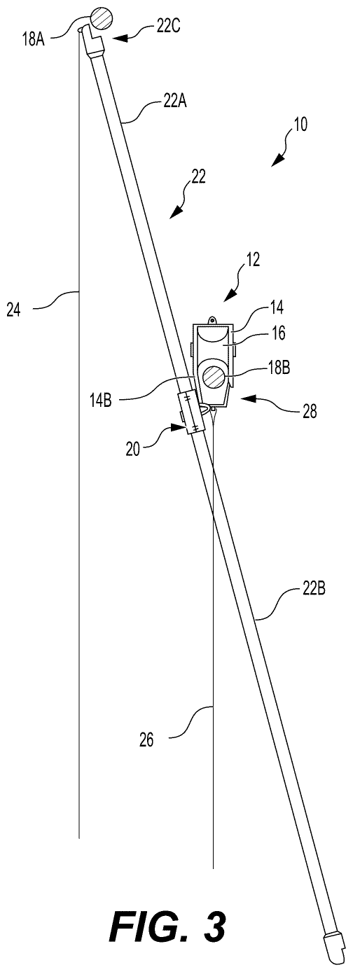

In some embodiments, stick support clamp hinge 36 may be positioned to one side of the lower end 14A of block housing 14. For example, stick support clamp hinge 36 may be positioned on the side of lower end 14A nearest conductor 18A. In such an embodiment, stick support clamp hinge 36 is thus positioned approximately directly under the side of conductor 18B, which is closest to conductor 18A, so that both distances L1 and L3 are being measured from substantially the same starting point relative to one another when horizontal. Further, this positioning may improve the accuracy of the reading of distance L1 as compared to distance L3, especially when measuring stick 22 is rotated about stick support clamp hinge 36, for example, as depicted in FIGS. 2 and 3. Further, the position of stick support clamp hinge 36 on the side of lower end 14A of block housing 14 closest to conductor 18A may allow for an extended range of motion in the rotation of measuring stick 22 about stick support clamp hinge 36.

In some embodiments, rolling conductor block-mounted clearance measuring stick 10 may be lightweight. For example, rolling conductor block-mounted clearance measuring stick 10 may weigh in the range of 3 to 5 pounds (or approximately 1.5 to 2 kilograms). This weight may include the combined weight of measuring stick 22, stick support clamp 20, roller 16, block housing 14, first line 24, and second line 26. In some embodiments, when mounted, conductor 18B may apply a downward force or deflection on rolling conductor block-mounted clearance measuring stick 10. For example, conductor 18B may slightly bend measuring stick 22, which affects the accuracy of the L1 and/or L3 measurements. Decreasing a weight of rolling conductor block-mounted clearance measuring stick 10 may reduce this downward force effect and improve measuring accuracy.

FIG. 2 illustrates example rolling conductor block-mounted clearance measuring stick 10 depicted in FIG. 1 in a rotated orientation, consistent with some disclosed embodiments. For example, three-phase conductors may be arranged in a triangular or delta arrangement. A triangular arrangement may include a middle conductor positioned higher (in a high position) than the other two conductors (in low positions) or a middle conductor positioned lower (in a low position) than the other two conductors (in high positions). Similarly, two-phase conductors may be arranged with one conductor positioned higher (in a high position) than another conductor (in a low position).

In some embodiments, second stick end 22B may be configured to act as a counterweight end of measuring stick 22. For example, second stick end 22B may act as a counterweight end of measuring stick 22 when an operator or lineworker is pulling down on or maintaining a tension of first line 24, with stick support clamp hinge 36 acting as a fulcrum. For example, and as depicted in FIG. 2, the downward tension on first line 24 may be relaxed so that second stick end 22B rotates downwardly, thereby elevating first stick end 22A. In this way, block-mounted clearance measuring stick 10 may be used to measure a clearance distance (L3) between conductors 18A and 18B. In some embodiments, second stick end 22B may act as a counterweight by being heavier than first stick end 22A. For example, second stick end 22B may comprise a denser and/or heavier material compared to first stick end 22A. Additionally, or alternatively, in some embodiments, second stick end 22B may be longer than first stick end 22A. For example, when L2 is greater than L1, second stick end 22B may be heavier than first stick end 22A.

FIG. 3 illustrates example rolling conductor block-mounted clearance measuring stick 10 depicted in FIG. 1 in a vertical orientation, consistent with some disclosed embodiments. For example, two- or three-phase conductors may be arranged in a vertical arrangement. A vertical arrangement may include conductors arranged such that they form a substantially vertical line.

For example, and as depicted in FIG. 3, the downward tension on first line 24 may be relaxed so that second stick end 22B rotates downwardly, thereby elevating first stick end 22A. The downward tension on first line 24 may be completely relaxed such that second stick end 22B rotates downwardly and first stick end 22A rotates upwardly to an upper limit of the rotational range of motion (in direction B). In this extreme orientation, first stick end 22A may be positioned flush along sidewall 14B of block housing 14.

In some embodiments, a rotational range of motion of measuring stick 22 may depend at least in part on an angle of sidewall 14B. For example, when sidewall 14B is vertical and flat, measuring stick 22 may be rotatable about stick support clamp hinge 36 to a substantially vertical position. Further, when sidewall 14B is angled, measuring stick 22 may be rotatable in direction B until measuring stick 22 contacts sidewall 14B. For example, sidewall 14B may be angled such that a top of sidewall 14B may hang over a bottom of sidewall 14B, thereby forming an acute angle with a horizontal plane of stick support clamp hinge 36.

FIG. 4 illustrates a rear elevation view of example block housing 14 in an open configuration, an example roller 16, and an example stick support clamp 20 in an open configuration, consistent with some disclosed embodiments

In some embodiments, stick support clamp 20 may be configured to releasably hold measuring stick 22. For example, stick support clamp 20 may be a clamshell clamp having opposed-facing half-shells 20A and 20B. Half-shells 20A and 20B may be configured to open in a direction C about a linear hinge 20C. Stick support clamp 20 may further include a latch 20D configured to hold half-shells 20A and 20B in a closed position. Although stick support clamp 20 is depicted as a clamshell clamp in FIG. 4, it may be understood that other forms of releasable clamps, closures, and fasteners may similarly be used.

For example, in some embodiments, block housing 14 may include a self-closing gate mechanism 28. Self-closing gate mechanism 28 may include a gate 30. In some embodiments, gate 30 may be pivotally mounted on a hinge 34 on lower end 14A of block housing 14. For example, gate 30 may rotate about hinge 34 between an open configuration and a closed configuration. In some embodiments, gate 30 may provide an opening into a cavity 32 in block housing 14 when gate 30 is in the open configuration. In the open configuration, conductor 18B may be passed in direction A into cavity 32. Further, when positioned in cavity 32, conductor 18B may engage roller 16, thereby allowing roller 16 to run over and along a length of conductor 18B.

In some embodiments, free end 30A of gate 30 may be resiliently biased so as to press against shoulder 14C on block housing 14 so as to hold the gate 30 closed across the opening into cavity 32. When gate 30 is in the closed configuration, conductor 18B may be contained within block housing 14 such that roller 16 is engaged on conductor 18B. In this way, roller 16 may roll along conductor 18B substantially without slippage or losing contact with conductor 18B. Further, gate 30 may prevent conductor 18B from leaving cavity 32.

In some embodiments, gate 30 may be spring-loaded. For example, gate 30 may include a spring (not depicted) configured to bias gate 30 in a closed configuration. When pressing against gate 30 using a force greater than the spring force maintaining gate 30 in the closed configuration, for example to insert conductor 18B into cavity 32, gate 30 may open. When conductor 18B is present in cavity 32 and a force applied to gate 30 is not greater than the spring force, the spring may force gate 30 shut.

In some embodiments, cavity 32 in block housing 14 may be sized to contain roller 16 and conductor 18B. In some embodiments, roller 16 may be rotatably mounted to block housing 14 on a transverse axle 16A for rotation about axis of rotation D. Axis of rotation D may be transverse to a longitudinal direction along the length of conductor 18B. For example, axis of rotation D may correspond to directions D and D′ depicted in FIG. 1.

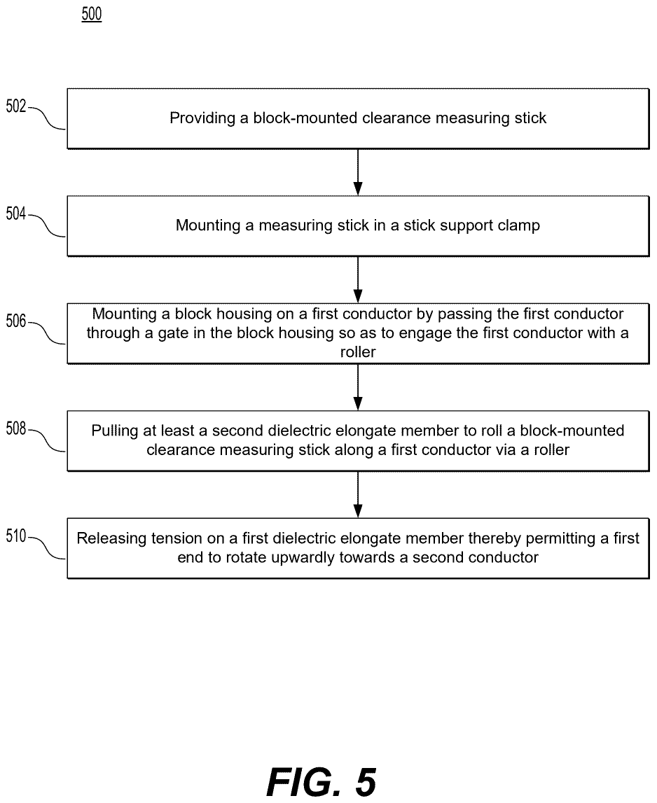

FIG. 5 illustrates a flow diagram of an example process 500 for using a rolling conductor block-mounted clearance measuring stick, consistent with some disclosed embodiments. It is intended that the sequence of steps shown in FIG. 5 is only for illustrative purposes and are not intended to be limited to any particular sequence of steps. As such, those skilled in the art can appreciate that these steps can be performed in a different order while implementing the same method. For example, in some embodiments, step 506 may be performed before step 504.

Step 502 of process 500 includes providing a block-mounted clearance measuring stick. For example, the block-mounted clearance measuring stick may include a rolling conductor block including a block housing and a roller mounted in the block housing, a stick support clamp pivotally mounted to a lower end of the block housing, a dielectric measuring stick configured to be mounted in the stick support clamp, a first dielectric elongate member mountable to a first end of the measuring stick, and a second dielectric elongate member mountable to the block housing. Further, the block-mounted clearance measuring stick may include block-mounted clearance measuring stick 10 described and exemplified in this disclosure.

Step 504 of process 500 includes mounting a measuring stick in a stick support clamp. For example, an operator or lineworker may position the measuring stick in stick support clamp and may adjust the positioning of the measuring stick such that a first end of the measuring stick has a length corresponding to the clearance distance between two conductors. The operator or lineworker may then close and/or lock the stick support clamp to prevent the measuring stick from moving, thereby ensuring the first end has a desired length.

In some embodiments, before, during, or after step 504, process 500 may include attaching a first dielectric elongate member to a mount at the end of the first end and attaching a second dielectric elongate member to a lower end of the block housing.

Step 506 of process 500 includes mounting a block housing on a first conductor by passing the first conductor through a gate in the block housing so as to engage the first conductor with a roller. For example, using a dielectric hot stick or similar apparatus (not depicted), an operator or lineworker may raise the block housing to capture a conductor through a gate of the block housing into a cavity. Once inside the cavity, the conductor may be engaged with a roller of the block housing.

Step 508 of process 500 includes pulling at least a second dielectric elongate member to roll a block-mounted clearance measuring stick along a first conductor via a roller. For example, an operator or lineworker may pull on the first dielectric elongate member and/or the second dielectric elongate member to roll the roller along the conductor to a desired location for measuring a clearance distance. Further, an operator or lineworker may also maintain a tension on the first dielectric elongate member while pulling to prevent the measuring stick from rotating about the stick support clamp.

Step 510 of process 500 includes releasing tension on a first dielectric elongate member thereby permitting a first end to rotate upwardly towards a second conductor. For example, when the block housing is pulled to the desired location along the first conductor for measuring the clearance distance to the second conductor, an operator or lineworker may pull down on the first dielectric elongate member to lower the first end of the measuring stick. Then the operator or lineworker may release the tension on the first dielectric elongate member so that the first end of the measuring stick raises up (e.g., as pulled by the second end of the measuring stick acting as a counterweight). In some embodiments, the operator or lineworker may push the first dielectric elongate member to raise the first end. For example, the first dielectric elongate member may be inflexible along at least part of its length.

When the first end of the measuring stick raises, an operator or lineworker may observe whether the first end clears the second conductor without contacting the second conductor. If the first end does not contact (e.g., bump into) the second conductor, then the clearance between conductors 18A and 18B is sufficient (i.e., at least minimum clearance distance achieved). If the first end does contact (e.g., bump into) the second conductor, then the clearance is insufficient (i.e., minimum clearance distance not achieved).

Additionally, or alternatively, in some embodiments, the first end may comprise a sensor configured to detect contact with or distance to a conductor. Responsive to detecting contact or distance within a predetermined threshold, the sensor may output a signal to an operator or lineworker indicating the minimum clearance distance is not present. For example, the sensor may transmit a signal to an operator or lineworker device, such as a smartphone or computer, to display an alert that the minimum clearance distance is not achieved. Further, the sensor may cause an alert to be output. For example, the alert may be a visual alert (e.g., blinking or flashing light), an audio alert (e.g., warning sound, verbal statement that the minimum clearance distance is not achieved), a haptic alert (e.g., vibration of device), or any combination of the foregoing.

Additional aspects of the present disclosure may be further described via the following clauses:
Clause 1. A block-mounted clearance measuring stick, comprising:
   a rolling conductor block including a block housing and a roller mounted in the block housing, wherein the roller is configured to roll along a conductor;
   a stick support clamp pivotally mounted to a lower end of the block housing;
   a dielectric measuring stick configured to be mounted in the stick support clamp;
   a first dielectric elongate member mountable to a first end of the measuring stick; and
   a second dielectric elongate member mountable to the block housing.
Clause 2. The block-mounted clearance measuring stick of clause 1, wherein the rolling conductor block and the stick support clamp comprise a conductive material.
Clause 3. The block-mounted clearance measuring stick of clause 1 or 2, wherein the rolling conductor block and the stick support clamp comprise a dielectric material.
Clause 4. The block-mounted clearance measuring stick of any one of clauses 1-3, wherein the first elongate member and second elongate member each comprise a first inflexible segment and a second flexible segment contiguous with the first inflexible segment.
Clause 5. The block-mounted clearance measuring stick of clause 4, wherein
   the first inflexible segments are lightweight dielectric rods, and
   the second flexible segments are chosen from a group consisting of: a rope, a cord, and a string.
Clause 6. The block-mounted clearance measuring stick of any one of clauses 1-5, wherein the first elongate member and second elongate member are flexible along their entire length and are chosen from a group consisting of a rope, a cord, and a string.
Clause 7. The block-mounted clearance measuring stick of any one of clauses 1-6, wherein
   the block housing includes a gate configurable between an open configuration and a closed configuration,
   the gate is configured to provide an opening into a cavity in the block housing in the open configuration, and
   the gate is configured to prevent the conductor from leaving the cavity.
Clause 8. The block-mounted clearance measuring stick of any one of clauses 1-7, wherein the stick support clamp is pivotally mounted on the block housing by a stick support clamp hinge.
Clause 9. The block-mounted clearance measuring stick of clause 8, wherein the stick support clamp hinge is a single degree-of-freedom hinge configured to confine rotation of the stick support clamp and measuring stick, when mounted in the stick support clamp, to a vertical plane orthogonal to the conductor.
Clause 10. The block-mounted clearance measuring stick of any one of clauses 1-9, wherein
   the conductor is a first conductor,
   the measuring stick is linear and, when positioned and mounted in the stick support clamp, the measuring stick has a first end extending in a first direction from the stick support clamp and a second end extending in a second direction opposite the first direction from the stick support clamp, and
   a length of the first end is a clearance distance between the first conductor when engaging the roller in the block housing and a second conductor.
Clause 11. The block-mounted clearance measuring stick of clause 10, wherein the length of the first end is less than a length of the second end so that the second end of the measuring stick provides a counterweight to a weight of the first end.
Clause 12. The block-mounted clearance measuring stick of any one of clauses 1-11, further comprising a mount configured to be secured to the measuring stick.
Clause 13. The block-mounted clearance measuring stick of clause 12, wherein
   the mount is secured to an end of the first end, and
   an end of the first line is secured to the mount.
Clause 14. The block-mounted clearance measuring stick of clause 12 or 13, wherein the mount includes an eye bolt, an eye screw, a clevis, a shackle, a swivel eye hook, a threaded insert with a carabiner or snap hook, or a ferrule with a loop.
Clause 15. The block-mounted clearance measuring stick of clause 12 or 13, wherein the mount includes a clamp-on rope ring, a socket adapter with an eyelet, or a quick-release coupler.
Clause 16. The block-mounted clearance measuring stick of clause 12 or 13, wherein the mount includes a hole or a through-bore in the measuring stick.
Clause 17. The block-mounted clearance measuring stick of any one of clauses 1-16, wherein the dielectric measuring stick is lightweight.
Clause 18. A method of using a block-mounted clearance measuring stick, the method comprising:
   providing the block-mounted clearance measuring stick, comprising:
      a rolling conductor block including a block housing and a roller mounted in the block housing, wherein the roller is configured to roll along a first conductor;
      a stick support clamp pivotally mounted to a lower end of the block housing;
      a dielectric measuring stick configured to be mounted in the stick support clamp;
      a first dielectric elongate member mountable to a first end of the measuring stick; and
      a second dielectric elongate member mountable to the block housing;
   mounting the measuring stick in the stick support clamp;
   mounting the block housing on the first conductor by passing the first conductor through a gate in the block housing so as to engage the first conductor with the roller;
   while holding a tension on the first dielectric elongate member thereby keeping the first end of the measuring stick away from a second conductor, pulling at least the second dielectric elongate member to roll the block-mounted clearance measuring stick along the first conductor via the roller; and
   releasing the tension on the first dielectric elongate member thereby permitting the first end to rotate upwardly towards the second conductor.
Clause 19. The method of clause 18, wherein the rolling conductor block and the stick support clamp comprise a conductive material.
Clause 20. The method of clause 18 or 19, wherein the rolling conductor block and the stick support clamp comprise a dielectric material.
Clause 21. The method of any one of clauses 18-20, wherein
   the first elongate member and second elongate member each comprise a first inflexible segment and a second flexible segment contiguous with the first inflexible segment,
   the first inflexible segments are lightweight dielectric rods, and
   the second flexible segments are chosen from a group consisting of: a rope, a cord, and a string.
Clause 22. The method of any one of clauses 18-21, wherein the first elongate member and second elongate member are flexible along their entire length and are chosen from a group consisting of a rope, a cord, and a string.
Clause 23. The method of any one of clauses 18-22, wherein
   the block housing includes a gate configurable between an open configuration and a closed configuration,
   the gate is configured to provide an opening into a cavity in the block housing in the open configuration, and
   the gate is configured to prevent the conductor from leaving the cavity.
Clause 24. The method of any one of clauses 18-23, wherein the stick support clamp is pivotally mounted on the block housing by a stick support clamp hinge.
Clause 25. The method of clause 24, wherein the stick support clamp hinge is a single degree-of-freedom hinge configured to confine rotation of the stick support clamp and measuring stick, when mounted in the stick support clamp, to a vertical plane orthogonal to the conductor.
Clause 26. The method of any one of clauses 18-25, wherein
   the conductor is a first conductor,
   the measuring stick is linear and, when positioned and mounted in the stick support clamp, has a first end extending in a first direction from the stick support clamp and a second end extending in a second direction opposite the first direction from the stick support clamp, and
   a length of the first end is a clearance distance between the first conductor when engaging the roller in the block housing and a second conductor.
Clause 27. The method of any one of clauses 18-26, wherein the dielectric measuring stick is lightweight.

The foregoing descriptions have been presented for purposes of illustration. They are not exhaustive and are not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

It should be noted that, the relational terms herein such as “first” and “second” are used only to differentiate an entity or operation from another entity or operation, and do not require or imply any actual relationship or sequence between these entities or operations. These terms are used to distinguish one element from another. For example, a first element could be termed a second element, and, similarly, a second element could be termed a first element, without departing from the scope of the embodiments.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the terms “and/or” and “or” encompass all possible combinations, except where infeasible. For example, if it is stated that a system may include A or B, then, unless specifically stated otherwise or infeasible, the system may include A, or B, or A and B. As a second example, if it is stated that a system may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A block-mounted clearance measuring stick, comprising:
a rolling conductor block including a block housing and a roller mounted in the block housing, wherein the roller is configured to roll along a conductor;
a stick support clamp pivotally mounted to a lower end of the block housing;
a dielectric measuring stick configured to be mounted in the stick support clamp;
a first dielectric elongate member mountable to a first end of the measuring stick; and
a second dielectric elongate member mountable to the block housing.

2. The block-mounted clearance measuring stick of claim 1, wherein the rolling conductor block and the stick support clamp comprise a conductive material.

3. The block-mounted clearance measuring stick of claim 1, wherein the rolling conductor block and the stick support clamp comprise a dielectric material.

4. The block-mounted clearance measuring stick of claim 1, wherein the first elongate member and second elongate member each comprise a first inflexible segment and a second flexible segment contiguous with the first inflexible segment.

5. The block-mounted clearance measuring stick of claim 4, wherein
the first inflexible segments are lightweight dielectric rods, and
the second flexible segments are chosen from a group consisting of: a rope, a cord, and a string.

6. The block-mounted clearance measuring stick of claim 1, wherein the first elongate member and second elongate member are flexible along their entire length and are chosen from a group consisting of a rope, a cord, and a string.

7. The block-mounted clearance measuring stick of claim 1, wherein
the block housing includes a gate configurable between an open configuration and a closed configuration,
the gate is configured to provide an opening into a cavity in the block housing in the open configuration, and
the gate is configured to prevent the conductor from leaving the cavity.

8. The block-mounted clearance measuring stick of claim 1, wherein the stick support clamp is pivotally mounted on the block housing by a stick support clamp hinge.

9. The block-mounted clearance measuring stick of claim 8, wherein the stick support clamp hinge is a single degree-of-freedom hinge configured to confine rotation of the stick support clamp and measuring stick, when mounted in the stick support clamp, to a vertical plane orthogonal to the conductor.

10. The block-mounted clearance measuring stick of claim 1, wherein
the conductor is a first conductor,
the measuring stick is linear and, when positioned and mounted in the stick support clamp, the measuring stick has a first end extending in a first direction from the stick support clamp and a second end extending in a second direction opposite the first direction from the stick support clamp, and
a length of the first end is a clearance distance between the first conductor when engaging the roller in the block housing and a second conductor.

11. The block-mounted clearance measuring stick of claim 10, wherein the length of the first end is less than a length of the second end so that the second end of the measuring stick provides a counterweight to a weight of the first end.

12. A method of using a block-mounted clearance measuring stick, the method comprising:
providing the block-mounted clearance measuring stick, comprising:
a rolling conductor block including a block housing and a roller mounted in the block housing, wherein the roller is configured to roll along a first conductor;
a stick support clamp pivotally mounted to a lower end of the block housing;
a dielectric measuring stick configured to be mounted in the stick support clamp;
a first dielectric elongate member mountable to a first end of the measuring stick; and
a second dielectric elongate member mountable to the block housing;
mounting the measuring stick in the stick support clamp;
mounting the block housing on the first conductor by passing the first conductor through a gate in the block housing so as to engage the first conductor with the roller;
while holding a tension on the first dielectric elongate member thereby keeping the first end of the measuring stick away from a second conductor, pulling at least the second dielectric elongate member to roll the block-mounted clearance measuring stick along the first conductor via the roller; and
releasing the tension on the first dielectric elongate member thereby permitting the first end to rotate upwardly towards the second conductor.

13. The method of claim 12, wherein the rolling conductor block and the stick support clamp comprise a conductive material.

14. The method of claim 12, wherein the rolling conductor block and the stick support clamp comprise a dielectric material.

15. The method of claim 12, wherein
the first elongate member and second elongate member each comprise a first inflexible segment and a second flexible segment contiguous with the first inflexible segment,
the first inflexible segments are lightweight dielectric rods, and
the second flexible segments are chosen from a group consisting of: a rope, a cord, and a string.

16. The method of claim 12, wherein the first elongate member and second elongate member are flexible along their entire length and are chosen from a group consisting of a rope, a cord, and a string.

17. The method of claim 12, wherein
the block housing includes a gate configurable between an open configuration and a closed configuration,
the gate is configured to provide an opening into a cavity in the block housing in the open configuration, and
the gate is configured to prevent the conductor from leaving the cavity.

18. The method of claim 12, wherein the stick support clamp is pivotally mounted on the block housing by a stick support clamp hinge.

19. The method of claim 18, wherein the stick support clamp hinge is a single degree-of-freedom hinge configured to confine rotation of the stick support clamp and measuring stick, when mounted in the stick support clamp, to a vertical plane orthogonal to the conductor.

20. The method of claim 12, wherein
the conductor is a first conductor,
the measuring stick is linear and, when positioned and mounted in the stick support clamp, has a first end extending in a first direction from the stick support clamp and a second end extending in a second direction opposite the first direction from the stick support clamp, and
a length of the first end is a clearance distance between the first conductor when engaging the roller in the block housing and a second conductor.
